(19) United States
(12) Patent Application Publication
(10) Pub. No.: US 2026/0005299 A1
(43) Pub. Date: Jan. 1, 2026

(54) IONIC ORGANIC FRAMEWORK ELECTROLYTE FOR ALL-SOLID-STATE SECONDARY BATTERY, COMPRISING MULTIPLE COMPONENTS, PREPARATION METHOD THEREFOR, AND ALL-SOLID-STATE SECONDARY BATTERY COMPRISING SAME

(71) Applicant: INDUSTRY-UNIVERSITY COOPERATION FOUNDATION HANYANG UNIVERSITY ERICA CAMPUS, Ansan-si (KR)

(72) Inventors: Jong Ho KIM, Ansan-si (KR); Jun Hyeong LEE, Ansan-si (KR); Jae Hoon SHIN, Ansan-si (KR); Jae Woo LEE, Ansan-si (KR)

(21) Appl. No.: 19/319,629

(22) Filed: Sep. 4, 2025

Related U.S. Application Data
(63) Continuation of application No. PCT/KR2024/009725, filed on Jun. 9, 2024.

(30) Foreign Application Priority Data
Aug. 11, 2023 (KR) 10-2023-0105712

(51) Int. Cl. H01M 10/0565

(52) U.S. Cl. CPC H01M 10/0565; H01M 2300/0082

(57) ABSTRACT

Provided is an ionic covalent organic framework electrolyte for all-solid-state secondary batteries, comprising: a crystalline organic framework having pores; and a glycol-based compound bonded to the organic framework, wherein the glycol-based compound is covalently bonded to the crystalline organic framework.

### CROSS-REFERENCE TO RELATED APPLICATION

This application is a bypass continuation of pending PCT International Application No. PCT/KR2024/009725, which was filed on Jul. 9, 2024, and which claims priority to and the benefit of Korean Patent Application No. 10-2023-0105712, which was filed in Korean Intellectual Property Office on Aug. 11, 2023, the disclosure of which are incorporated herein by reference in its entirety.

### TECHNICAL FIELD

The present invention relates to an ionic organic skeleton electrolyte for all-solid-state secondary batteries containing multi-components, a manufacturing method thereof, and all-solid-state secondary batteries including the same. More specifically, the present invention relates to an ionic organic skeleton electrolyte for all-solid-state secondary batteries containing multi-components, which has a very simple synthesis process, a high synthesis yield, very high ionic conductivity and lithium ion transport number at room temperature, and excellent thermal and electrochemical stability, as well as to a method for manufacturing the same and an all-solid-state secondary battery comprising the same.

### BACKGROUND ART

Currently used lithium-ion secondary batteries have a very high risk of ignition and explosion due to the use of liquid electrolytes. In addition, the low thermal and electrochemical stability of liquid electrolytes makes it impossible to develop high-voltage and high-energy-density lithium-ion batteries.

Therefore, in order to overcome these limitations, the development of all-solid-state lithium secondary batteries is actively being pursued. To realize this, it is essential to develop solid electrolytes with excellent ionic conductivity and electrochemical stability. However, the previously developed inorganic solid electrolytes have limitations in that they are very difficult to manufacture and process, have poor contact with the electrode surface resulting in very high interfacial resistance, and exhibit low electrochemical stability.

To overcome the disadvantages of such inorganic solid electrolytes, amorphous polymer-based organic solid electrolytes are being developed. However, due to still low room-temperature ionic conductivity, thermal and electrochemical instability, and low lithium-ion transport number, side reactions such as dendrite growth and formation of non-uniform SEI layers occur, which significantly reduce charge-discharge stability and make practical application difficult.

### DISCLOSURE

### Technical Problem

The technical problem to be solved by the present invention is to provide an electrolyte for all-solid-state secondary batteries and a method for preparing the same, which exhibits very high ionic conductivity and lithium ion transport number at room temperature, and has excellent thermal and electrochemical stability.

### Technical Solution

In order to solve the above-described problem, the present invention provides an ionic covalent organic framework electrolyte for all-solid-state secondary batteries, comprising: a crystalline organic framework having pores; and a glycol-based compound bonded to the organic framework, wherein the glycol-based compound is covalently bonded to the crystalline organic framework.

In one embodiment of the present invention, the crystalline organic framework having pores includes a plurality of pyridinium ions as basic components of the organic framework.

In one embodiment of the present invention, the glycol-based compound is diethylene glycol (DEG), and the diethylene glycol (DEG) is covalently bonded to a pyridinic nitrogen site of the pyridinium.

In one embodiment of the present invention, migration of metal ions in the ionic covalent organic framework electrolyte for all-solid-state secondary batteries includes hopping behavior of the metal ions at oxygen sites of the diethylene glycol (DEG).

In one embodiment of the present invention, migration of metal ions in the ionic covalent organic framework electrolyte for all-solid-state secondary batteries includes vehicle behavior of the diethylene glycol (DEG) itself.

In one embodiment of the present invention, the ionic covalent organic framework electrolyte for all-solid-state secondary batteries further includes an ionic succinonitrile.

In one embodiment of the present invention, the crystalline organic framework having pores includes at least one of the following structural formulas:

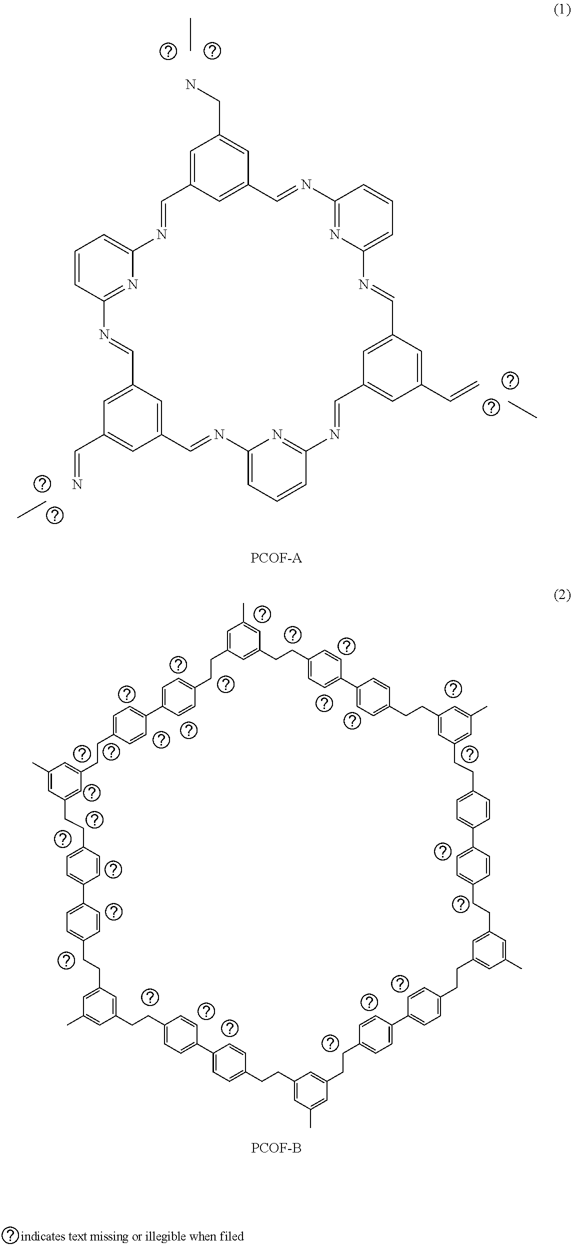

In one embodiment of the present invention, the ionic covalent organic framework electrolyte for all-solid-state secondary batteries further includes lithium bis(trifluoromethanesulfonyl)imide.

The present invention also provides an all-solid-state secondary battery comprising the above-described ionic covalent organic framework electrolyte for all-solid-state secondary batteries.

In one embodiment of the present invention, the all-solid-state secondary battery is a lithium all-solid-state secondary battery.

The present invention also provides a method for preparing an ionic covalent organic framework electrolyte for all-solid-state secondary batteries, comprising: a step of preparing a crystalline organic framework having pores; and a step of bonding a glycol-based compound to the organic framework, wherein the glycol-based compound is covalently bonded to the crystalline organic framework.

In one embodiment of the present invention, the step of preparing the crystalline organic framework comprises reacting triphenyltricarbaldehyde and a pyridine compound, and the glycol-based compound is diethylene glycol (DEG).

In one embodiment of the present invention, the diethylene glycol (DEG) is covalently bonded to a pyridinic nitrogen site of the pyridinium in the organic framework.

### BRIEF DESCRIPTION OF DRAWINGS

FIGS. 1 and 2 are schematic diagrams illustrating the fabrication process and structure of a covalent organic framework into which multiple components are introduced, according to one embodiment of the present invention.

FIGS. 3 to 6 show the results of physical structure analysis of the covalent organic framework into which multiple components are introduced, according to one embodiment of the present invention.

FIGS. 7 to 9 show the results of chemical structure analysis of the covalent organic framework into which multiple components are introduced.

FIGS. 10 to 16 show the results of electrochemical property and ionic conductivity analysis of the solid electrolyte based on MC-PCOF-A.

FIGS. 17 and 18 show the results of analyzing lithium ion transport mechanisms of the solid-state electrolyte based on MC-PCOF-A through molecular dynamics simulation.

In particular, FIG. 18 confirms the diffusion mechanism of lithium ions through the time-dependent distance between oxygen and lithium ions in (a)-(c).

FIGS. 19 to 23 show the performance analysis results of the all-solid-state lithium metal battery using the MC-PCOF-A-based solid electrolyte.

FIG. 19 shows the structure of the assembled all-solid-state lithium metal battery.

FIG. 20 shows the charge/discharge capacity variation according to the number of cycles.

FIG. 21 shows the cycling stability at room temperature.

FIG. 22 shows the capacity and Coulombic efficiency stability at various charge/discharge rates.

FIG. 23 shows the capacity variation at various charge/discharge rates.

### BEST MODE

The present invention may be subjected to various modifications and may have a variety of embodiments. Specific embodiments are illustrated in the drawings and described in detail in the following detailed description. However, this is not intended to limit the present invention to particular embodiments, and it should be understood to include all modifications, equivalents, and substitutes included within the spirit and scope of the present invention.

In describing the present invention, detailed descriptions of well-known technologies may be omitted when it is determined that such descriptions would obscure the gist of the present invention.

In order to solve the above-described problems, the present invention introduces a glycol-based compound such as DEG into a crystalline covalent organic framework (COF) having a porous structure. As a result, the electrolyte exhibits very high ionic conductivity and lithium ion transference number at room temperature, and has excellent thermal and electrochemical stability. These features will be described in more detail below.

The solid electrolyte according to the present invention is prepared by: 1) synthesizing a crystalline organic framework containing a pyridinium compound as a basic component, by reacting a pyridine-based compound with triphenyltricarbaldehyde; and 2) covalently bonding a glycol-based compound to the nitrogen (pyridinium) site of the pyridine in the organic framework. Therefore, depending on the structure of the pyridine compound, it is possible to prepare solid electrolytes in various forms. Below, examples synthesized in two types are described, but the scope of the present invention is not limited thereto.

### EXAMPLES

### Synthesis of PCOF-A

1. 1,3,5-triformylbenzene and 2,6-diaminopyridine were dissolved in a mixed solution of mesitylene and 1,4-dioxane (1:1 v/v) in a three-neck round-bottom flask under an argon atmosphere.
2. The mixture was sonicated for 10 minutes, and then acetic acid (6 M) was added to the reaction mixture at room temperature.
3. The reaction was carried out at 120° C. for 72 hours.
4. The reaction mixture was centrifuged at 12,000 rpm to obtain the porous covalent organic framework (PCOF), and the obtained PCOF was washed three times with tetrahydrofuran.
5. The PCOF was dispersed in N-methyl-2-pyrrolidone (NMP), and an aqueous NaOH solution (pH 8.0) was added for neutralization.
6. After stirring the solution for 10 minutes, it was centrifuged at 12,000 rpm for 10 minutes to obtain the neutralized PCOF, which was washed three times with water and acetone, respectively.
7. The collected powder was dried under high vacuum for 12 hours.

### Synthesis of PCOF-B

1. 1,3,5-triformylbenzene and 2,2′-bipyridine-5,5′-diamine were dissolved in a mixed solution of mesitylene and 1,4-dioxane (9:1 v/v) in a three-neck round-bottom flask under an argon atmosphere.
2. The mixture was sonicated for 10 minutes, and then acetic acid (4 M) was added to the reaction mixture at room temperature.
3. The reaction was carried out at 80° C. for 72 hours.
4. The reaction mixture was centrifuged at 12,000 rpm to obtain the porous covalent organic framework (PCOF), and the obtained PCOF was washed three times with tetrahydrofuran.
5. The PCOF was dispersed in N-methyl-2-pyrrolidone (NMP), and an aqueous NaOH solution (pH 8.0) was added for neutralization.
6. After stirring the solution for 10 minutes, it was centrifuged at 12,000 rpm for 10 minutes to obtain the neutralized PCOF, which was washed three times with water and acetone, respectively.
7. The collected powder was dried under high vacuum for 12 hours.

### Synthesis of Multi-Component Porous Covalent Organic Framework (MC-PCOF) and Fabrication of All-Solid-State Electrolyte

1. The previously obtained PCOF-A and PCOF-B were dispersed in NMP in a three-neck round-bottom flask under an argon atmosphere, followed by sonication for 10 minutes.
2. Diethylene glycol 2-bromoethyl methyl ether was added to the PCOF solution, and the resulting mixture was stirred at 120° C. for 24 hours.
3. After cooling the reaction solution, an excess amount of ethyl acetate was added to precipitate the desired product.
4. The product MC-PCOF was obtained by centrifugation at 12,000 rpm for 10 minutes and washed three times with ethyl acetate.
5. The dried MC-PCOF was mixed with succinonitrile, lithium bis(trifluoromethanesulfonyl)imide (LiTFSI), and PVDF, and NMP was added. The resulting mixture was molded into a pellet form and dried at 80° C. for 24 hours to fabricate the all-solid-state electrolyte.

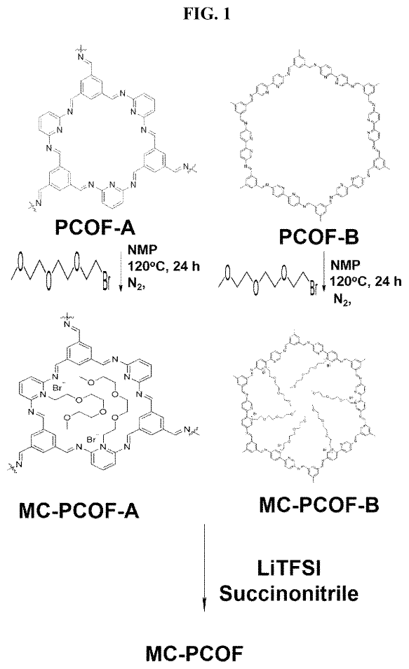

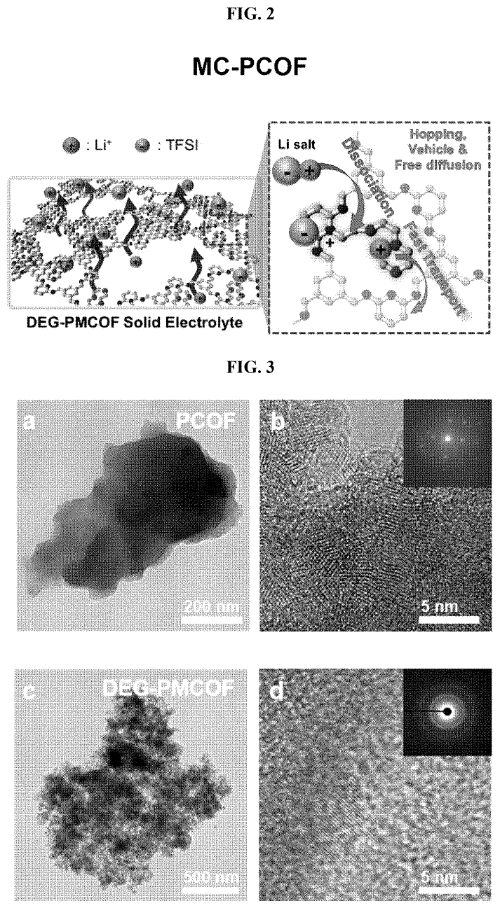

FIGS. 1 and 2 are schematic diagrams illustrating the fabrication process and structure of a covalent organic framework into which multiple components are introduced, according to one embodiment of the present invention.

Referring to FIGS. 1 and 2, it can be seen that upon treatment with diethylene glycol 2-bromoethyl methyl ether, the pure pyridine-rich COF (PCOF) is converted into MC-PCOF, a DEG-modified pyridinium form. DEG is predominantly introduced at the pyridinic nitrogen (N) sites of the PCOF, rather than at the anilinic nitrogen sites. This is due to the much higher nucleophilicity of the pyridinic nitrogen (see FIG. 2).

The MC-PCOF, which is the basic structure of the multi-component-introduced covalent organic framework according to one embodiment of the present invention, is designed to facilitate the dissociation of lithium salts and to provide multiple pathways for fast lithium-ion transport in all-solid-state lithium metal batteries (LMBs). That is, the incorporation of DEG into the covalent organic framework in the present invention provides the advantages of high room-temperature ionic conductivity (σ=1.71×10⁻⁴S·cm⁻¹), a lithium-ion transference number at room temperature (tLi⁺=0.61), and a wide electrochemical stability window. The pyridinium components of the MC-PCOF exhibit high polarity and electrochemical stability, thereby promoting the dissociation of tightly bound lithium ion pairs into two mobile ionic species.

In addition, in one embodiment of the present invention, diethylene glycol (DEG), which is one of the multi-components introduced into the rigid crystalline pyridine-rich covalent organic framework electrolyte, is flexible and polar in nature, and can effectively transport lithium ions through both hopping and vehicle motion in the solid electrolyte.

### EXPERIMENTAL EXAMPLE

FIGS. 3 to 6 show the physical structure analysis results of the covalent organic framework into which multi-components are introduced, according to one embodiment of the present invention.

In FIG. 3, (a-b) show the TEM images of PCOF-A and (c-d) show the TEM images of MC-PCOF-A.

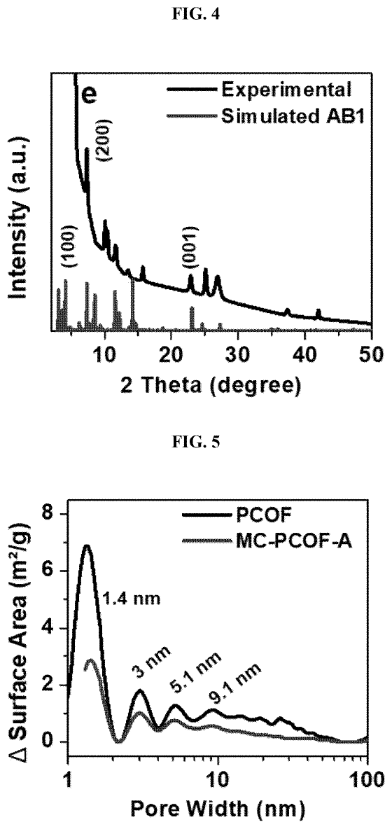

FIG. 4 shows the XRD analysis result of PCOF-A.

FIG. 5 shows the pore size distribution based on BET analysis.

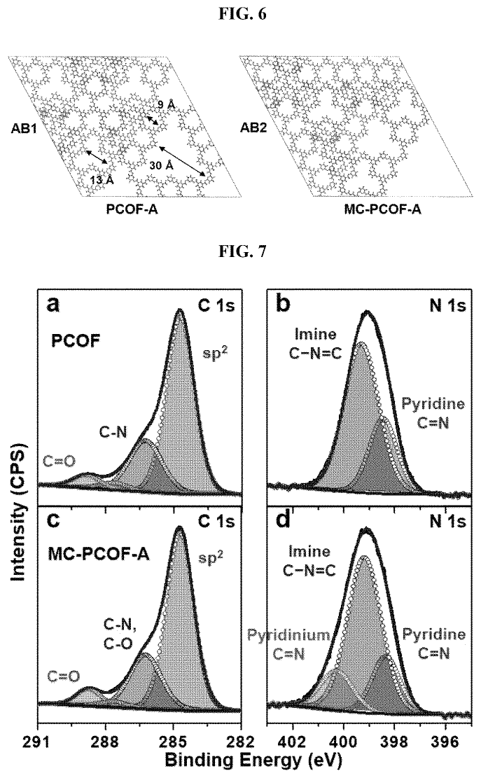

FIG. 6 presents the stacking structure analysis of PCOF-A and MC-PCOF-A.

Referring to FIGS. 3 to 6, it can be seen that the covalent organic framework with multiple components introduced via DEG still maintains its pore size and crystallinity.

FIGS. 7 to 9 show the chemical structure analysis results of the covalent organic framework into which multi-components are introduced.

In FIG. 7, (a-b) show the XPS spectra of PCOF-A, and (c-d) show the XPS spectra of MC-PCOF-A.

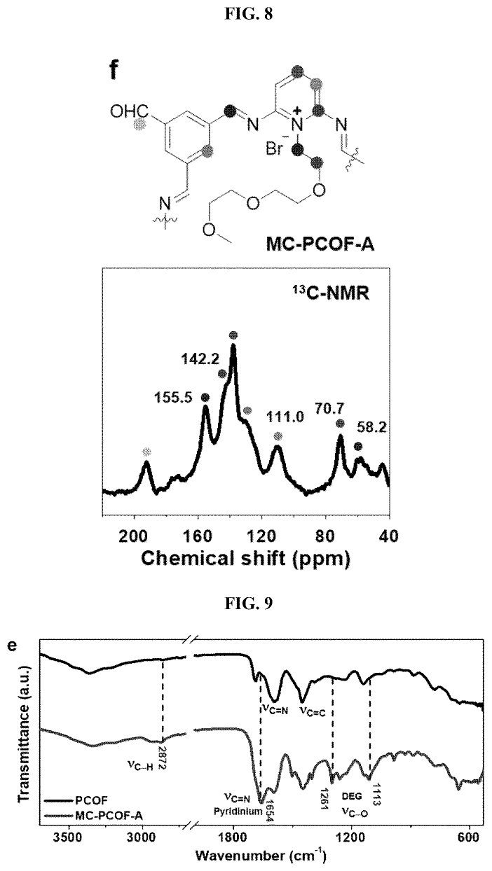

FIG. 8 shows the 13C\hat{ }{13}C13C-NMR analysis result of MC-PCOF-A.

FIG. 9 shows the FT-IR analysis result comparing PCOF and MC-PCOF-A.

Referring to FIGS. 7 to 9, it can be confirmed that the solid electrolyte according to the present invention retains a structure that is identical or similar to that prior to DEG introduction.

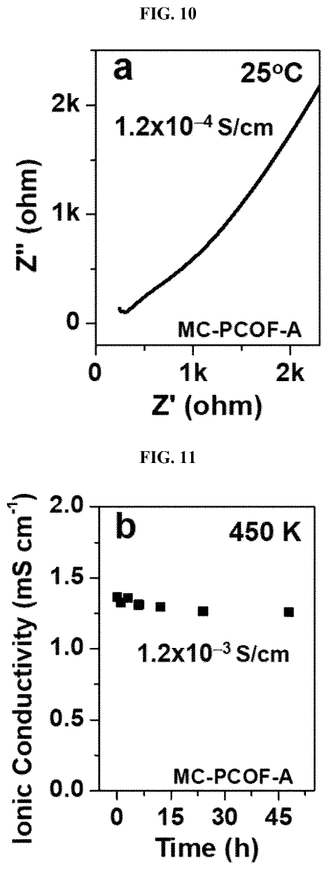

FIGS. 10 to 16 show the electrochemical properties and ionic conductivity analysis results of the solid electrolyte based on MC-PCOF-A.

FIG. 10 shows the ionic conductivity at room temperature confirmed by Nyquist plot.

FIG. 11 shows the ionic conductivity stability at 450 K.

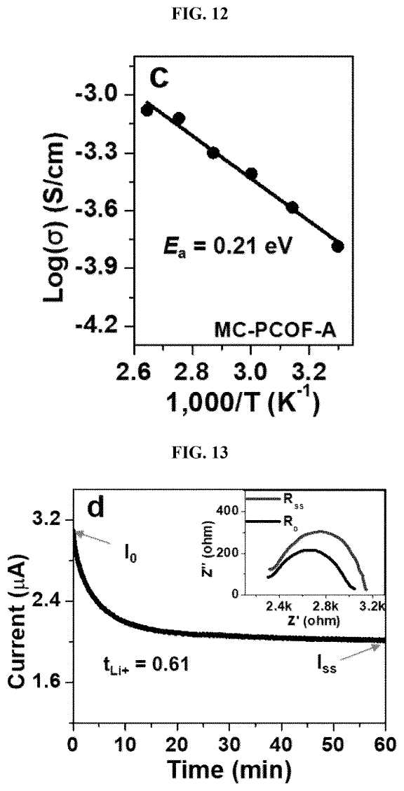

FIG. 12 shows the temperature-dependent ionic conductivity from an Arrhenius plot.

FIG. 13 shows the lithium ion transference number obtained by chronoamperometry in a Li|MC-PCOF-A|Li symmetric cell at room temperature.

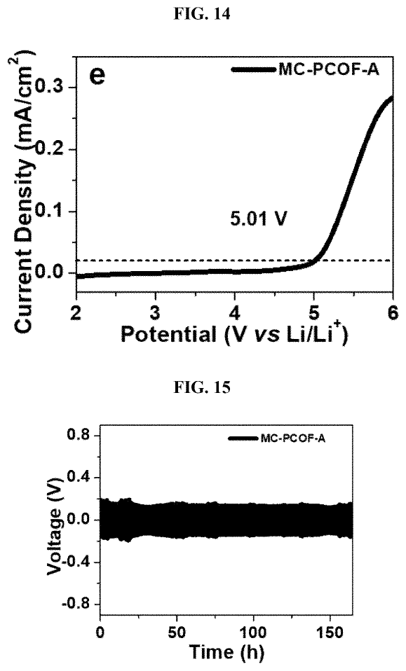

FIG. 14 shows the oxidative stability verified by oxidative potential analysis.

FIG. 15 shows the lithium plating/stripping stability.

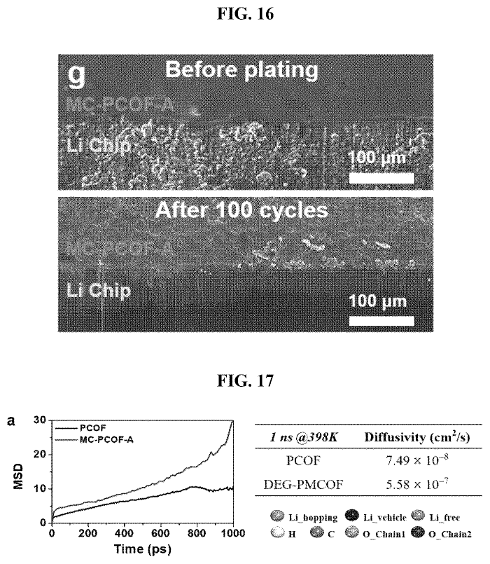

FIG. 16 shows the SEM images of the electrode interface after 100 cycles.

Referring to FIGS. 10 to 16, it is confirmed that the solid electrolyte according to the present invention exhibits superior performance compared to conventional polymer electrolytes in terms of ionic conductivity, lithium-ion transference number, oxidative stability, and dendrite suppression. In particular, the introduction of DEG into the covalent organic framework results in high room-temperature ionic conductivity (σ=1.71×10⁻⁴S·cm⁻¹) and a lithium-ion transference number (tLi⁺=0.61), as clearly demonstrated by these results.

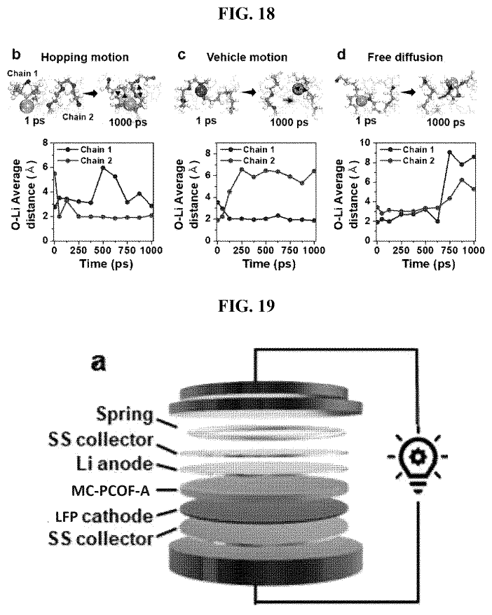

FIGS. 17 and 18 show the analysis results for lithium-ion transport behavior in the all-solid-state electrolyte based on MC-PCOF-A, as obtained through molecular dynamics (MD) simulation. In FIG. 18, (a-c) confirm the lithium-ion diffusion mechanism based on time-dependent distances between oxygen and lithium ions.

Referring to FIGS. 17 and 18, lithium-ion diffusion in the MC-PCOF-based solid electrolyte of the present invention occurs via three modes: hopping, vehicle, and free diffusion behavior. The MD simulation results indicate that the diffusion behavior of Li⁺ ions can be classified based on their interactions with DEG chains as below.
1. Hopping Behavior

As shown in FIG. 5(a), hopping behavior refers to the movement in which dissociated lithium ions jump between oxygen sites of adjacent DEG chains. From the time-dependent analysis of the average O-Li distance, it can be seen that a lithium ion adjacent to Chain 1 hops to a neighboring Chain 2, and in some cases, fully transitions around 375 ps and maintains a new average distance thereafter.
2. Vehicle Behavior

During the hopping movement, as shown in FIG. 5(b), a single DEG chain can transfer a lithium ion through a vehicle-like motion, enabling lithium ion migration between neighboring chains.
3. Free Diffusion Behavior

Due to the limited chain length of the DEG group, the diffusion range of vehicle-like motion is restricted. As a result, in the final stage, the lithium ion undergoes free diffusion behavior, as shown in FIG. 5(c).

Accordingly, in the absence of DEG incorporation as in the present invention, lithium ion migration would occur only through free diffusion. However, the DEG introduced in the present invention provides additional transport mechanisms: 1) lithium ion migration between oxygen sites of DEG, and 2) lithium ion migration by movement of the DEG chain itself.

Therefore, it is confirmed that lithium ions migrate through diffusion mechanisms in the solid electrolyte of the present invention. This is believed to be the effect of the glycol-based compound covalently introduced into the pyridinium-rich covalent organic framework.

FIGS. 19 to 23 show the performance analysis results of all-solid-state lithium metal batteries using the MC-PCOF-A-based solid electrolyte.

FIG. 19 shows the structure of the assembled all-solid-state lithium metal battery.

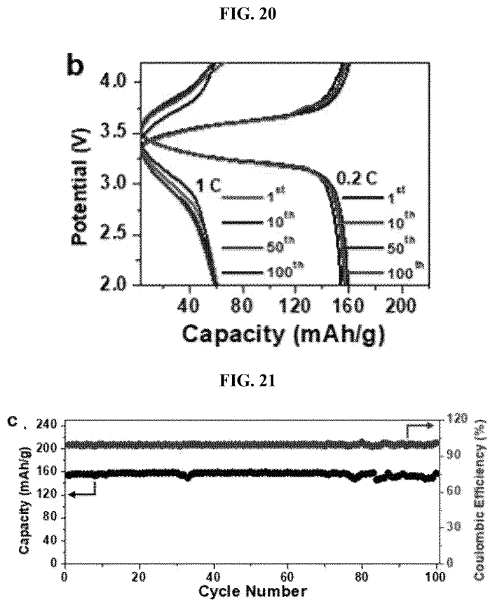

FIG. 20 shows the charge/discharge capacity variation over cycle number.

FIG. 21 shows the cycle stability at room temperature.

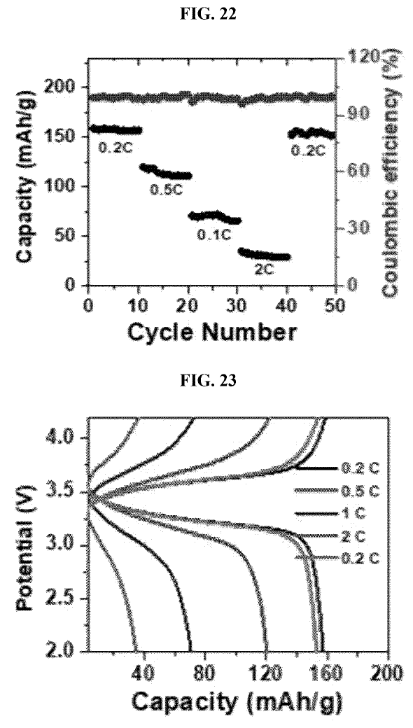

FIG. 22 shows the capacity and Coulombic efficiency stability under various charge/discharge rates.

FIG. 23 shows the capacity variation under different charge/discharge rates.

Referring to FIGS. 19 to 23, it is confirmed that the solid electrolyte according to the present invention exhibits excellent cycling stability and charge/discharge efficiency. While the invention has been described in detail with reference to specific parts of the invention, such detailed description is merely one example of a preferred embodiment for those skilled in the art. It will be apparent that such specific descriptions do not limit the scope of the present invention. Accordingly, the true scope of the invention is defined by the appended claims and their equivalents.

### INDUSTRIAL APPLICABILITY

The present invention relates to an MC-PCOF solid electrolyte and is applicable to all-solid-state lithium metal secondary batteries. Therefore, it has industrial applicability.

1. An ionic covalent organic framework electrolyte for all-solid-state secondary batteries,
comprising: a crystalline organic framework having pores; and a glycol-based compound bonded to the organic framework, wherein the glycol-based compound is covalently bonded to the crystalline organic framework.

2. The electrolyte of claim 1, wherein the crystalline organic framework having pores comprises a plurality of pyridinium ions as base components of the organic framework.

3. The electrolyte of claim 1, wherein the glycol-based compound is diethylene glycol (DEG).

4. The electrolyte of claim 1, wherein the diethylene glycol (DEG) is covalently bonded to a pyridinic nitrogen site of the pyridinium.

5. The electrolyte of claim 4, wherein migration of metal ions in the electrolyte occurs through hopping behavior at oxygen sites of the diethylene glycol (DEG).

6. The electrolyte of claim 4, wherein migration of metal ions in the electrolyte occurs through vehicle behavior via movement of the diethylene glycol (DEG) itself.

7. The electrolyte of claim 6, wherein the electrolyte further comprises ionic succinonitrile.

8. The electrolyte of claim 7, wherein the crystalline organic framework having pores comprises at least one of the following structural formulas:

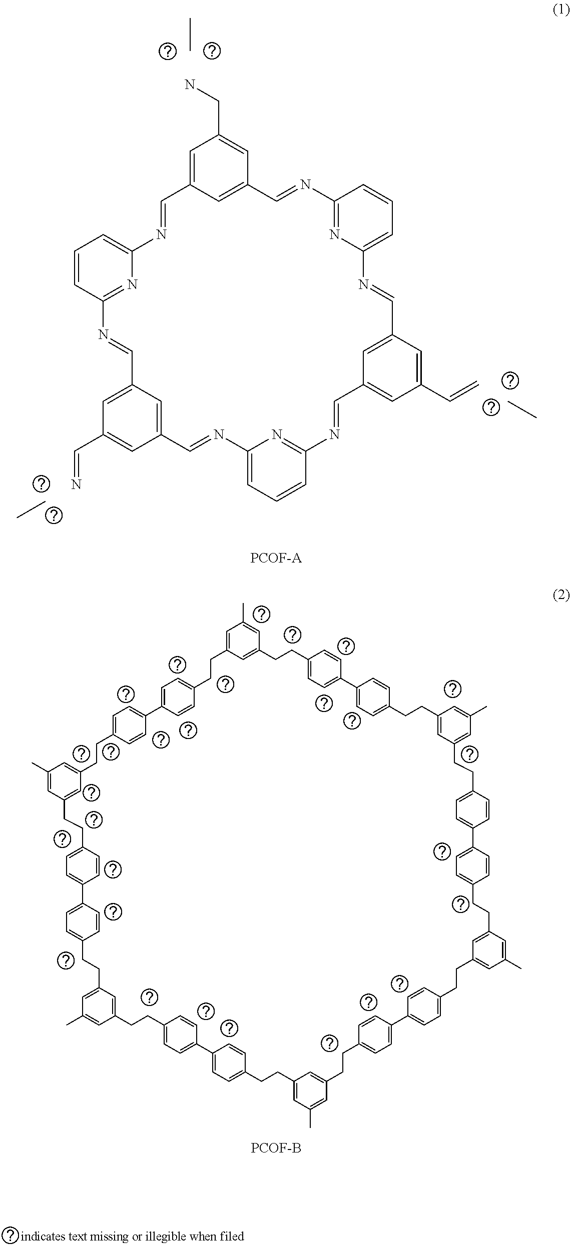

9. The electrolyte of claim 6, wherein the electrolyte further comprises lithium bis(trifluoromethanesulfonyl)imide.
